(19) United States
(12) Patent Application Publication
(10) Pub. No.: US 2007/0010998 A1
(43) Pub. Date: Jan. 11, 2007

(54) Dynamic generative process modeling, tracking and analyzing

(76) Inventors: Regunathan Radhakrishnan, Attleboro, MA (US); Ajay Divakaran, Burlington, MA (US)

Correspondence Address: Mitsubishi Electric Research Laboratories, Inc.;Patent Department, 201 Broadway, Cambridge, MA, 02139, US

(21) Appl. No.: 11/177,917

(22) Filed: Jul. 8, 2005

(51) Int. Cl. G10L 21/00

(52) U.S. Cl. 704/211

(57) ABSTRACT

A method tracks and analyzes dynamically a generative process that generates multivariate time series data. In one application, the method is used to detect boundaries in broadcast programs, for example, a sports broadcast and a news broadcast. In another application, significant events are detected in a signal obtained by a surveillance device, such as a video camera or microphone.

### FIELD OF THE INVENTION

This invention relates generally to modeling, tracking and analyzing time series data generated by generative processes, and more particularly to doing this dynamically with a single statistical model.

### BACKGROUND OF THE INVENTION

The problem of tracking a generative process involves detecting and adapting to changes in the generative process. This problem has been extensively studied for visual background modeling. The intensity of each individual pixel in an image can be considered as being generated by a generative process that can be modeled by a multimodal probability distribution function (PDF). Then, by detecting and adapting to changes in the intensities, one can perform background-foreground segmentation.

Methods for modeling scene backgrounds can be broadly classified as follows. One class of methods maintains an adaptive prediction filter. New observations are predicted according to a current filter. This is based on the intuition that the prediction error for foreground pixels is large, see D. Koller, J. Weber and J. Malik, “Robust multiple car tracking with occlusion reasoning,” Proc. European Conf. on Computer Vision, pp. 189-196, 1994; K. P. Karman and A. von Brandt, “Moving object recognition using an adaptive background memory,” Capellini, editor, Time-varying Image Processing and Moving Object Recognition, pp. 297-307, 1990; and K. Toyoma, J. Krumm, B. Brumitt and B. Meyers, “Wallflower: Principles and practice of background maintenance,” Proc. ICCV, 1999.

Another class of methods adaptively estimates probability distribution functions for the intensities of pixels using a parametric model, see C. Stauffer and W. E. L. Grimson, “Learning patterns of activity using real-time tracking,” IEEE Trans. on Pattern Analysis and Machine Intelligence, pp. 747-757, 2000. There are several problems with that method. That method extracts color features for each pixel over time and models each pixel's color component independently with a separate mixture of Gaussian distribution functions. The assumption that each feature dimension evolves independently over time may be incorrect for some processes.

Other probabilistic methods are described by C. Wren, A. Azarbayejani, T. Darrell and A. Pentland, “Pfinder: Real-time tracking of the human body,” IEEE Transactions on Pattern Analysis and Machine Intelligence, vol. 19, no. 7, pp. 780-785, July 1997; O. Tuzel, et al., “A Bayesian approach to background modeling,” Proc. CVPR Workshop, Jun. 21, 2005; K. Toyoma, J. Krumm, B. Brumitt and B. Meyers, “Wallflower: Principles and practice of background maintenance,” Proc. ICCV, 1999; and N. Friedman and S. Russell, “Image segmentation in video sequences,” Conf. on Uncertainty in Artificial Intelligence, 1997.

Another class of methods uses a non-parametric density estimation to adaptively learn the density of the underlying generative process for pixel intensities, see D. Elgammal, D. Harwood and L. Davis, “Non-parametric model for background subtraction,” Proc. ECCV, 2000.

The method described by Stauffer et al. for visual background modeling has been extended to audio analysis, M. Cristani, M. Bicego and V. Murino, “On-line adaptive background modeling for audio surveillance,” Proc. of ICPR, 2004. Their method is based on the probabilistic modeling of the audio data stream using separate sets of adaptive Gaussian mixture models for each spatial sub-band of the spectrum. The main drawback with that method is that a GMM is maintained for each sub-band to detect outlier events in that sub-band, followed by a decision as to whether the outlier event is a foreground event or not. Again, like Stauffer et al., a large number of probabilistic models is hard to manage.

Another method detects ‘backgrounds’ and ‘foregrounds’ from a time series of cepstral features extracted from audio content, see R. Radhakrishnan, A. Divakaran, Z. Xiong and I. Otsuka, “A content-adaptive analysis and representation framework for audio event discovery from ‘unscripted’ multimedia,” Eurasip Journal on Applied Signal Processing, Special Issue on Information Mining from Multimedia, 2005; and U.S. patent application Ser. No. 10/840,824, “Multimedia Event Detection and Summarization,” filed by Radhakrishnan, et al., on May 7, 2004, and incorporated herein by reference. In that time series analysis, the generative process that generates most of the ‘normal’ or ‘regular’ data is referred to as a ‘background’ process. A generative process that generates short bursts of abnormal or irregular data amidst the dominant normal background data is referred to as the ‘foreground’ process. Using that method, one can detect ‘backgrounds’ and ‘foregrounds’ in time series data. For example, one can detect highlight segments in sports audio, significant events in a surveillance audio, and program boundaries in video content by detecting audio backgrounds from a time series of cepstral features. However, there are several problems with that method. Most important, the entire time series is required before events can be detected. Therefore, that method cannot be used for real-time applications such as, for example, for detecting highlights in a ‘live’ broadcast of a sporting event or for detecting unusual events observed by a surveillance camera. In addition, the computational complexity of that method is high. A statistical model is estimated for each subsequence of the entire time series, and all of the models are compared pair-wise to construct an affinity matrix. Again, the large number of statistical models and the static processing makes that method impractical for real-time applications.

Therefore, there is a need for a simplified method for tracking a generative process dynamically.

A number of techniques are known for recording and manipulating broadcast television programs (content), see U.S. Pat. No. 6,868,225, Multimedia program book marking system; U.S. Pat. No. 6,850,691, Automatic playback overshoot correction system; U.S. Pat. No. 6,847,778, Multimedia visual progress indication system; U.S. Pat. No. 6,792,195, Method and apparatus implementing random access and time-based functions on a continuous stream of formatted digital data; U.S. Pat. No. 6,327,418, Method and apparatus implementing random access and time-based functions on a continuous stream of formatted digital data; and U.S. Patent Application 20030182567, Client-side multimedia content targeting system.

The techniques can also include content analysis technologies to enable an efficient browsing of the content by a user. Typically, the techniques rely on an electronic program guide (EPG) for information regarding the start time and end time of programs. Currently, the EPG is updated infrequently, e.g., only four times a day in the U.S. However, the EPG does not always work for recording ‘live’ programs. Live programs, for any number of reasons can start late and can run over their allotted time. For example, sporting events can be extended in case of a tied score or due to weather delays. Therefore, it is desired to continue recording a program until the program completes, or alternatively, without relying completely on the EPG. Also, it is not uncommon for a regularly scheduled program to be interrupted by a news bulletin. In this case, it is desired to only record the regularly scheduled program.

### SUMMARY OF THE INVENTION

The invention provides a method for tracking and analyzing dynamically a generative process that generates multivariate time series data. In one application, the method is used to detect boundaries in broadcast programs, for example, a sports broadcast and a news broadcast. In another application, significant events are detected in a signal obtained by a surveillance device, such as a video camera or microphone.

### BRIEF DESCRIPTION OF THE DRAWINGS

FIGS. 1A, 1B, 2A, 2B are time series data to be processed according to embodiments of the invention;

FIG. 3 is a block diagram of a system and method according to one embodiment of the invention;

FIG. 4 is a block diagram of time series data to be analyzed;

FIG. 5 is a block diagram of a method for updating a multivariate model of a generative process; and

FIG. 6 is a block diagram of a method for modeling using low level and high level features of time series data.

### DETAILED DESCRIPTION OF THE PREFERRED EMBODIMENT

The embodiments of our invention provide methods for tracking and analyzing dynamically a generative process that generates multivariate data.

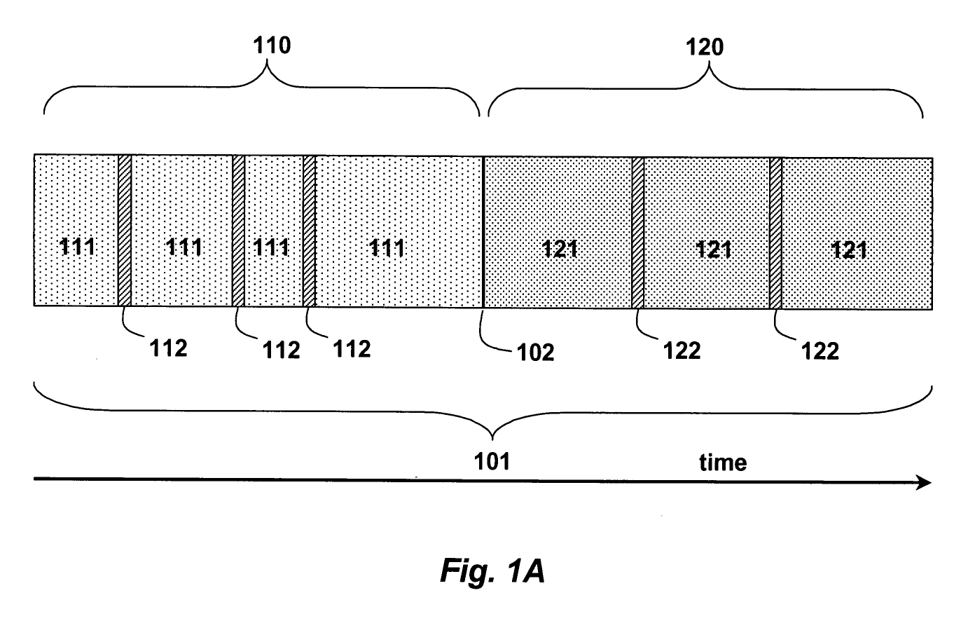

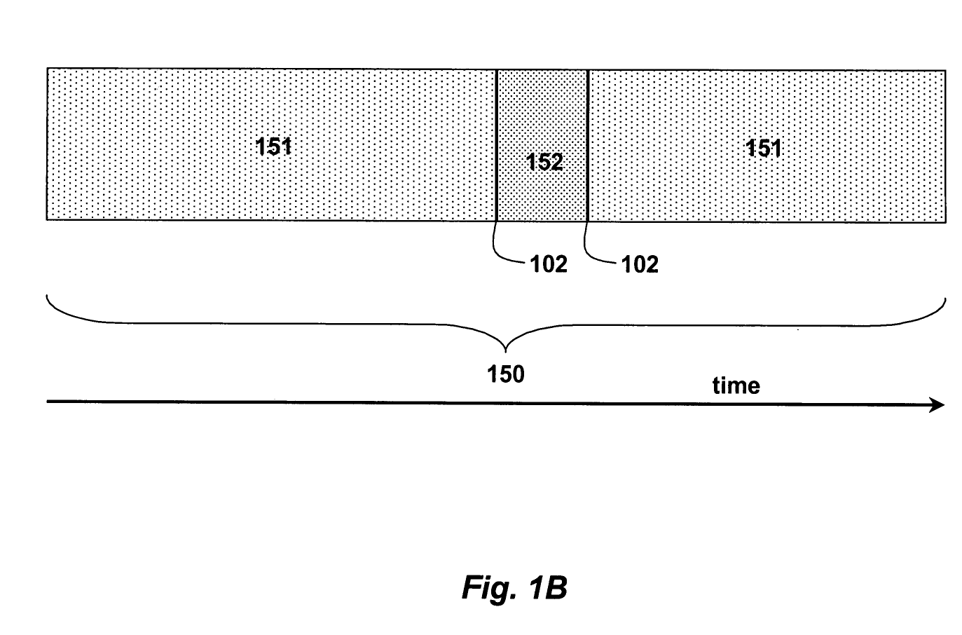

FIG. 1A shows a time series of multivariate data 101 in the form of a broadcast signal. The time series data 101 includes programs 110 and 120, e.g., a sports program followed by a news program. Both programs are dominated by ‘normal’ data 111 and 121 with occasional short bursts of ‘abnormal’ data 112 and 122. It is desired to detect dynamically a boundary 102 between the two programs, without prior knowledge of the underlying generative process.

FIG. 1B shows a time series 150, where a regularly scheduled broadcast program 151 that is to be recorded is briefly interrupted by an unscheduled broadcast program 152 not to be recorded. Therefore, boundaries 102 are detected.

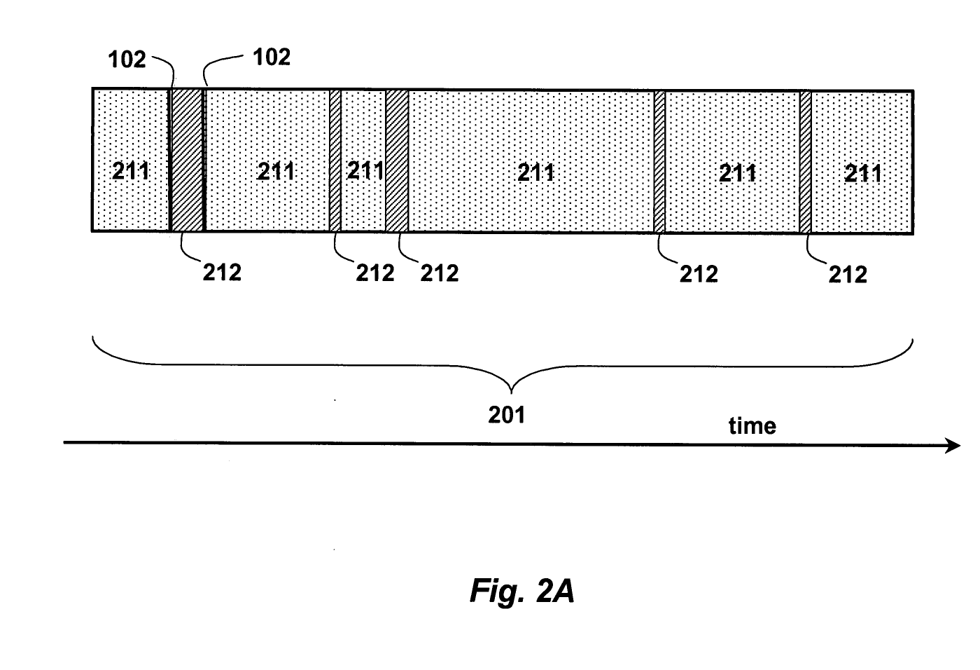

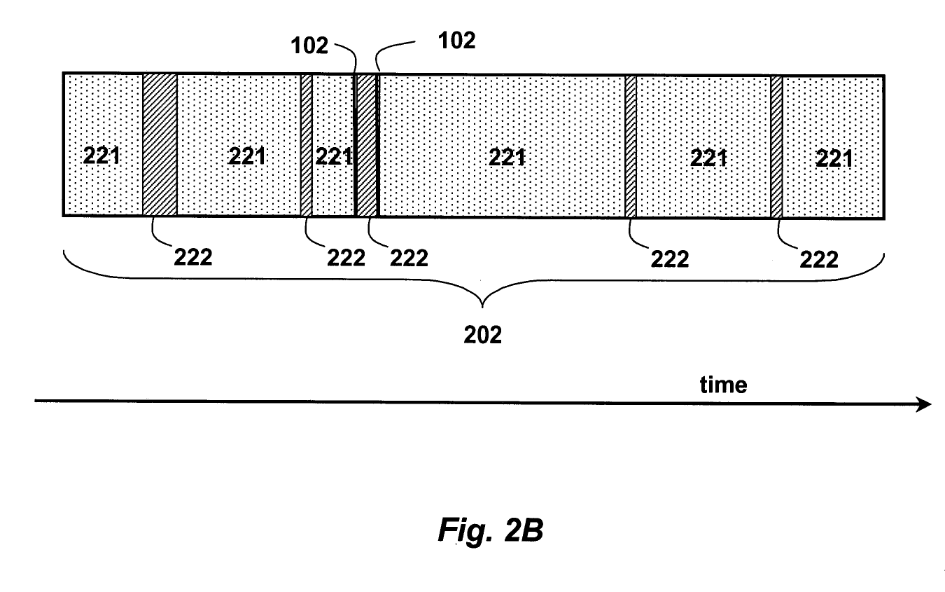

FIG. 2A shows another time series of multivariate data 201. The time series data 201 represents, e.g., a real-time surveillance signal. The time series data 201 is dominated by ‘normal’ data 211, with occasional short bursts of ‘abnormal’ data 212. It is desired to detect dynamically significant events without prior knowledge of the generative process that generates the data. This can then be used to generate an alert, or to record permanently significant events to reduce communication bandwidth and storage requirements. Therefore, boundaries 102 are detected.

FIG. 2B shows time series data 202 representing a broadcast program 221 to be recorded. The program is occasionally interrupted by broadcast commercials 222 not to be recorded. Therefore, boundaries 102 are detected so that the commercials can be skipped.

Although the embodiments of the invention are described with respect to a generative process that generates audio signals, it should be understood that the invention is applicable to any generative process that produces multivariate data, e.g., video signals, electromagnetic signals, acoustic signals, medical and financial data, and the like.

System and Method

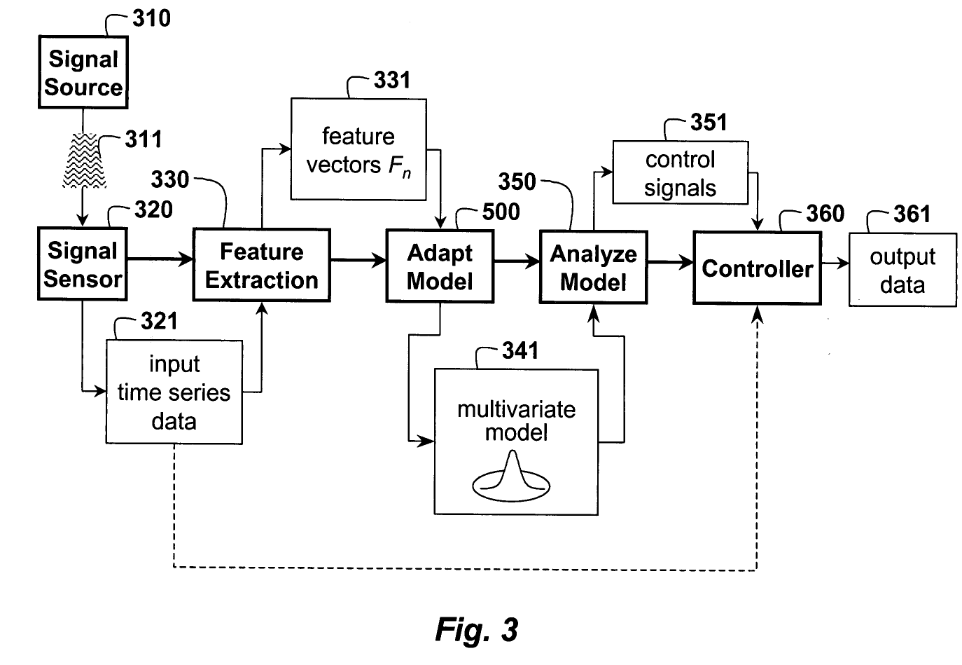

FIG. 3 shows a system and method for modeling, tracking and analyzing a generative process. A signal source 310 generates a raw signal 311 using some generative process. For the purpose of the invention, the process is not known. Therefore, it is desired to model this process dynamically, without knowing the generative process. That is, the generative process is ‘learned’, and a model 341 is adapted as the generative process evolves over time.

The signal source 310 can be an acoustic source, e.g., a person, a vehicle, a loudspeaker, a transmitter of electromagnetic radiation, or a scene emitting photon. The signal 311 can be an acoustic signal, an electromagnetic signal, and the like. A sensor 320 acquires the raw signal 311. The sensor 320 can be a microphone, a camera, a RF receiver, or an IR receiver, for example. The sensor 320 produces time series data 321.

It should be understood that the system and method can use multiple sensors for concurrently acquiring multiple signals. In this case, the time series data 321 from the various sensors are synchronized, and the model 341 integrates all of the various generative process into a single higher level model.

The time series data are sampled, using a sliding window W_{L}. It is possible to adjust the size and rate at which the sliding window moves forward in time over the time series data. For example, the size and rate is adjusted according to the evolving model 341.

Features are extracted 330 from the sampled time series data 321 for each window position or instant in time. The features can include low, middle, and high level features. For example, acoustic features can include pitch, amplitude, Mel frequency cepstral coefficients (MFCC), ‘speech’, ‘music’, ‘applause’, genre, artist, song title, or speech content. Features of a video can include spatial and temporal features. Low level features can include color, motion, texture, etc. Medium and high level features can include MPEG-7 descriptors and object labels. Other features as known in the art for the various signals can also be extracted 330.

It should also be understood that the particular type of features that are extracted can be adjusted over time. For example, features are selected dynamically for extraction according to the evolving model 341.

For each instance in time, the features are used to construct a feature vector 331.

Over time, the multivariate model 341 is adjusted 500 according to the feature vectors 331. The model 341 is in the form of a single Gaussian mixture model. The model includes a mixture of probability distribution functions (PDFs) or ‘components.’ It should be noted that the updating process considers the features to be dependent on (correlated to) each other within a feature vector. This is unlike the prior art, where a separate PDF is maintained for each feature, and the features are considered to be independent of each other.

As the model 341 evolves dynamically over time, the model can be analyzed 350. The exact analysis performed depends on the application, some of which, such as program boundary detection and surveillance, are introduced above.

The analysis 150 can produce control signals 351 for a controller 360. A simple control signal would be an alarm. More complex signals can control further processing of the time series data 321. For example, only selected portions of the time series data are recorded, or the time series data is summarized as output data 361.

Application to Surveillance

The system and method as described above can be used by a surveillance application to detect significant events. Significant events are associated with transition points of the generative process. Typically, significant ‘foreground’ events are infrequent and unpredictable with respect to usual ‘background’ events. Therefore, with the help of the adaptive model 341 of the generative background process, we can detect unusual events.

Problem Formulation

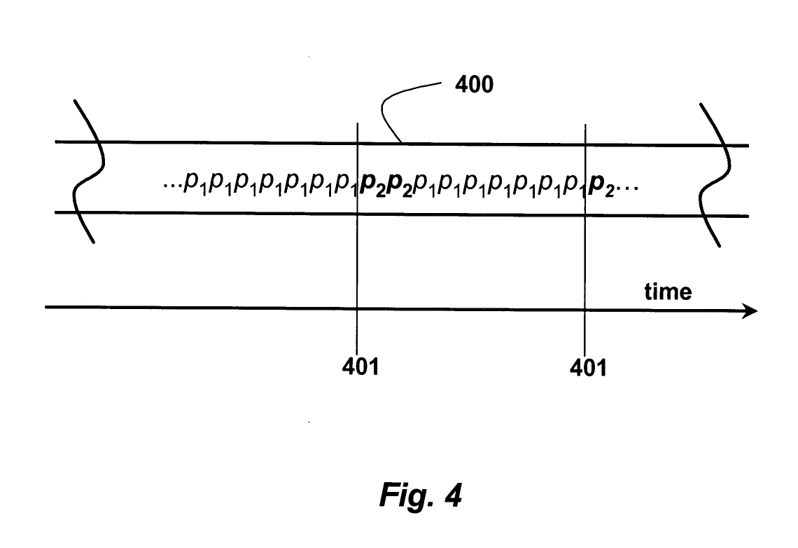

FIG. 4 shows time series data 400. Data p₁ are generated by an unknown generative process operating ‘normally’ in a background mode (P₁). Data p₂ are generated by the generative process operating abnormally in a foreground mode (P₂). Thus, the time series data 400 can be expressed as
. . . p₁p₁p₁p₁p₁p₁p₁p₂p₂p₂p₁p₁p₁p₁p₁p₁p₁
The problem is to find onsets 401 and times of occurrences of realizations of mode P₂ without any a priori knowledge of the modes P₁ and P₂.

Modeling

Given the feature vectors 331, we estimate the generative process operating in the background mode P₁ by training the GMM 341 with a relatively small number of feature vectors {F₁, F₂, . . . , F_{L}}.

The number of components in the GMM 341 is obtained by using the well known minimum description length (MDL) principle, J. Rissanen, “Modeling by the shortest data description,” Automatica 14, pp. 465-471, 1978.

The GMM model 341 is designated by G. The number of components in G 341 is K. We use notations π, μ and R to denote probability coefficients, means and variances of the components 341. Thus, the parameter sets for the K components are {πₖ}ₖ₌₁^{K}, {μₖ}ₖ₌₁^{K} and {Rₖ}ₖ₌₁^{K}, respectively.

Model Adjusting

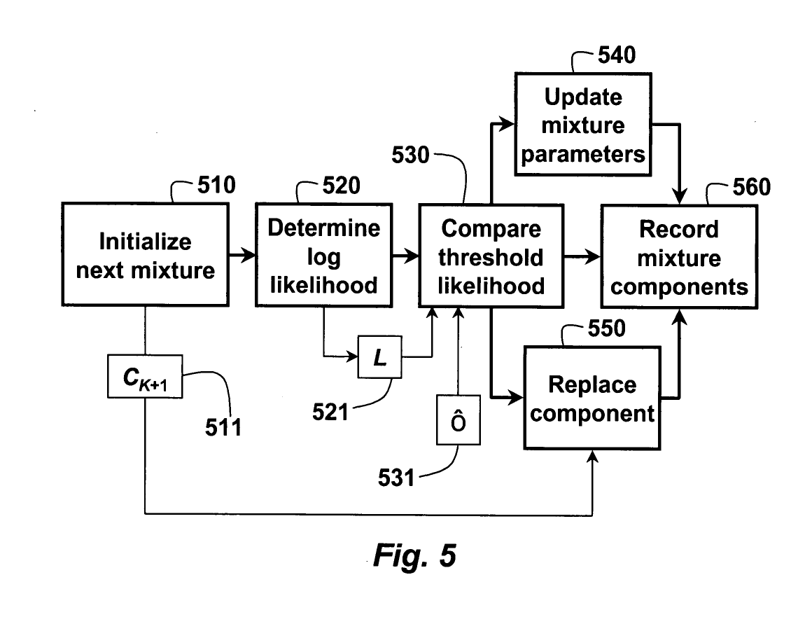

FIG. 5 shows the steps of the adjusting 500 the model 341 for each feature vector Fₙ 331. In step 510, we initialize a next component C_{K+1} 511 with a random mean, a relatively high variance diagonal covariance, and a relatively low mixture probability, and we normalize the probability coefficients π accordingly.

In step 520, we determine a likelihood L 521 of the feature vector 331 using the model 341. Then, we compare 530 the likelihood to a predetermined threshold τ 531.

If the log likelihood 521 is greater than the threshold 531, then we determine a most likely component that generated the feature vector Fₙ according to

$$j = arg {max}_{m} ( \frac{P ( {F}_{n} / \{ {μ}_{m} , {R}_{m} \} ) π}{P ( {F}_{n} / G )} ) ,$$

and update 540 the parameters of the most likely component j according to:
π_{j,t}=(1−α)π_{j,t-1}+α,
μ_{j,t}=(1−ρ)μ_{j,t-1}+ρFₙ, and
R_{j,t}=(1−ρ)R_{j,t-1}+ρ(Fₙ−μ_{j,t})^{T}(Fₙ−μ_{j,t})
where α and ρ are related to a rate for adjusting the model 341. For other components (h≠j), we update the probability coefficients according to:
π_{h,t}=(1−α)π_{h,t-}1, and
normalize the probability coefficient matrix π.

Otherwise, if the log likelihood 521 is less than the threshold, then we assume that the model 341, with the current K components, are inappropriate for modeling the feature vector Fₙ. Therefore, we replace 550 the mean of the component C_{K+1} with the feature vector Fₙ. As a result, we have added a new mixture component to the model to account for the current feature vector Fₙ that is inconsistent with the model. We also generate a new dummy component for prospective data in the future.

In step 560, we record the most likely components that are consistent with the feature vector Fₙ. Then, by examining a pattern of memberships to components of the model, we can detect changes in the underlying generative process.

Our method is different than the method of Stauffer et al. in a number of ways. We do not assume a diagonal covariance for the multivariate time series data. In addition, we use a likelihood value of the feature vector with respect to the current model to determine changes in the generative process. Furthermore, we have a single multivariate mixture model for each instant in time.

Application to Program Boundary Detection

We formulate the problem of program boundary detection as that of detecting a substantial change in the underlying generative process that generates the time series data that constitute different programs. This is motivated by the observation that, for example, a broadcast sports program is distinctively different from ‘non-sport’ programs, e.g., a news program or a movie.

In this embodiment, we use both low level features and high level features to reduce the amount of processing required. The low level features are Mel frequency cepstral coefficients, and the high level features are audio classification labels.

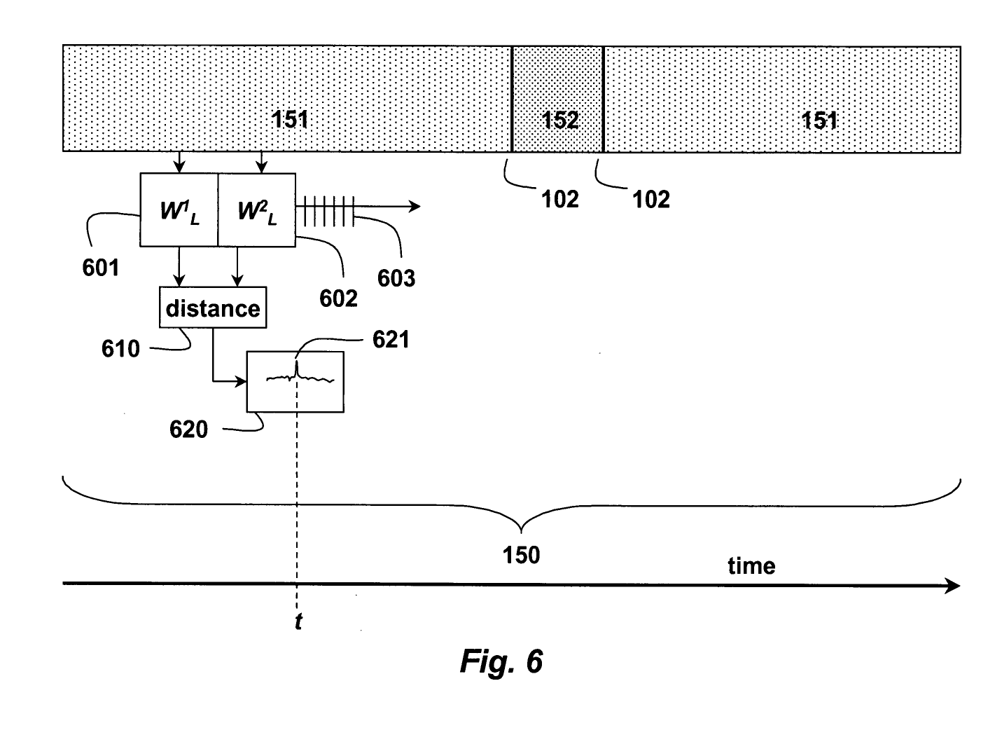

As shown in FIG. 6, we use two sliding windows, W¹_{L} 601 and W²_{L} 602, time-wise adjacent. The windows are stepped forward at fixed time intervals W_{S} 603. Labels in the two windows are compared to determine a distance 610 for each time step. The comparison can be performed using a Kullback-Leibler (KL) distance. The distances are stored in a buffer 620.

If there is a program boundary, a peak 621 in the KL distance is potentially indicative of a program change at time t. The peak can be detected using any known peak detection process. The program change is verified using the low level features and the multivariate model described above. However, in this case, the model only needs to be constructed for a small number of features before (G_{L}) and after (G_{R}) time t associated with the peak 621.

We can determine the distance between G_{L} and G_{R} according to:

$$D ( {G}_{L} , {G}_{R} ) = ( \frac{1}{\# ( {F}_{L} )} log P ( {F}_{L} \vert {G}_{L} ) ) + ( \frac{1}{\# ( {F}_{R} )} log P ( {F}_{R} \vert {G}_{R} ) ) - ( \frac{1}{\# ( {F}_{L} )} log P ( {F}_{L} \vert {G}_{R} ) ) - ( \frac{1}{\# ( {F}_{R} )} log P ( {F}_{R} \vert {G}_{L} ) )$$

Here, F_{L} and F_{R} are the low-level features to the left and to the right of the peak, and # represents the cardinality operator. By comparing the distance to a predetermined threshold, we can determine whether the peak is in fact associated with a program boundary. In essence, candidate changes in the generative process are detected using high level features, and low level features are used to verify that the candidate changes are actual changes.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for modeling a generative process dynamically, comprising:
acquiring time series data generated by a generative process;
sampling the time series data to extract a single feature vector for each instance in time while acquiring, the feature vector including a plurality of dependent features of the time series data, the sampling using a sliding window for each instance in time; and
updating dynamically a multivariate model according to the single feature vector for each instance in time while acquiring and sampling, the multivariate model including a mixture of Gaussian distribution functions.

2. The method of claim 1, in which the time series data is a broadcast signal including a plurality of programs, and further comprising:
detecting dynamically boundaries between the plurality of programs using the multivariate model, while acquiring, sampling and updating.

3. The method of claim 2, further comprising:
recording dynamically only selected programs between the program boundaries while acquiring, sampling and updating.

4. The method of claim 1, in which the time series data is a real-time surveillance signal, and further comprising:
detecting dynamically significant events in the real-time surveillance signal using the multivariate model while acquiring, sampling and updating.

5. The method of claim 4, further comprising:
generating an alarm signal in response to detecting the significant events.

6. The method of claim 1, in which the time series data is a broadcast signal including a program and a plurality of commercials;
detecting dynamically boundaries between the program and the plurality of commercials using the multivariate model while acquiring, sampling and updating; and
recording only the program.

7. The method of claim 1, in which the time series data is a broadcast signal including audio and video signals.

8. The method of claim 1, in which the time series data are acquired by a plurality of sensors.

9. The method of claim 1, further comprising:
adjusting dynamically a size of the sliding window and a rate of sampling of the time series data according to the multivariate model while acquiring, sampling and updating.

10. The method of claim 1, further comprising:
adjusting dynamically the types of the plurality of dependent features according to the multivariate model while acquiring, sampling and updating.

11. The method of claim 1, further comprising:
analyzing dynamically the multivariate model to generate a control signal while acquiring, sampling and updating.

12. The method of claim 11, further comprising:
processing dynamically the time series data according to the control signal while acquiring, sampling and updating.

13. The method of claim 1, in which a number of Gaussian distribution functions is determined according to a minimum description length principle.

14. The method of claim 1, in which each one of K Gaussian probability functions is denoted by a set of parameters, the sets of parameters including probability coefficients {πₖ}ₖ₌₁^{K}, means {μₖ}ₖ₌₁^{K}, and variances {Rₖ}ₖ₌₁^{K}.

15. The method of claim 1, further comprising:
determining a likelihood for each feature vector using the multivariate model; and
updating the multivariate model according to the likelihood.

16. The method of claim 1, in which each feature vector includes low level features and high level features, and further comprising:
detecting a candidate change in the multivariate model using the high level features; and
verifying the candidate change using the low level features.
